(19) United States
(12) Patent Application Publication
(10) Pub. No.: US 2024/0281637 A1
(43) Pub. Date: Aug. 22, 2024

(54) METHOD AND APPARATUS FOR PRUNING NEURAL NETWORK FILTERS BASED ON CLUSTERING

(71) Applicant: AGENCY FOR DEFENSE DEVELOPMENT, Daejeon (KR)

(72) Inventors: Daehwan KIM, Daejeon (KR); Juyoung LEE, Daejeon (KR); Hyunseong KANG, Daejeon (KR); Daikyung HYUN, Daejeon (KR)

(73) Assignee: AGENCY FOR DEFENSE DEVELOPMENT, Daejeon (KR)

(21) Appl. No.: 18/434,823

(22) Filed: Feb. 7, 2024

(30) Foreign Application Priority Data
Feb. 9, 2023 (KR) 10-2023-0017263

(51) Int. Cl. G06N 3/04

(52) U.S. Cl. CPC G06N 3/04

(57) ABSTRACT

One or more embodiments relate to a technology for pruning filters or reducing filters based on clustering. According to one or more embodiments, there is provided a method for pruning filters in neural networks, the method including obtaining a convolutional layer having a plurality of filters; generating a plurality of clusters by dividing the plurality of filters; calculating a geometric median for each of the plurality of clusters; and excluding at least one filter from among the plurality of filters based on the geometric median for each of the plurality of clusters.

### CROSS-REFERENCE TO RELATED APPLICATION

This application is based on and claims priority under 35 U.S.C. § 119 to Korean Patent Application No. 10-2023-0017263, filed on Feb. 9, 2023, in the Korean Intellectual Property Office, the disclosure of which is incorporated by reference herein in its entirety.

### BACKGROUND

### 1. Field

One or more embodiments relate to a technology for pruning filters or reducing filters based on clustering.

### 2. Description of the Related Art

Recently, in the fields of computer vision and image processing, studies on deep neural networks based on convolutional neural network (CNN) layers for object classification, recognition, video division, noise reduction, and video creation have been actively carried out.

CNN-based deep neural networks are showing significant advances in performance compared to the existing technology based on various datasets and advanced hardware. CNN-based deep neural networks have excellent inference performance, but require high-priced hardware such as high-performance graphics processing units (GPUs) for real-time processing, and particularly, the processing speed in low-power edge devices or devices such as central processing units (CPUs) except for GPUs is quiet slow and thus improvements in the processing speed are required.

According to these demands, technologies for pruning filters or reducing filters in CNN layers are emerging.

The background technology described above is technical information that was owned by the inventor or was acquired in the process of deriving the disclosure, and it is not necessarily technology available to the general public before the filing of the present application.

### SUMMARY

One or more embodiments include a method and an apparatus for pruning filters or reducing filters by using a geometric median based on clustering.

Additional aspects will be set forth in part in the description which follows and, in part, will be apparent from the description, or may be learned by practice of the presented embodiments of the disclosure.

According to one or more embodiments, there is provided a method for pruning filters in neural networks, the method including obtaining a convolutional layer having a plurality of filters, generating a plurality of clusters by dividing the plurality of filters, calculating a geometric median of each of the plurality of clusters, and excluding at least one filter from among the plurality of filters based on the geometric median for each of the plurality of clusters.

The generating of the plurality of clusters may include converting the plurality of filters into a Laplacian matrix, selecting k eigenvalues from the Laplacian matrix based on sizes of eigenvalues, obtaining eigenvectors respectively corresponding to the k eigenvalues, determining the plurality of clusters by dividing the plurality of filters using the eigenvectors.

The calculating of the geometric median of each of the plurality of clusters may include calculating a first geometric median of the first cluster based on the plurality of first clusters included in a first cluster from among the plurality of clusters.

The method may further include calculating first geometric distances defined as distances between the first geometric median and the plurality of first filters and determining priorities based on the first geometric distances, wherein the excluding of the at least one filter may include excluding at least one filter from among the plurality of first filters based on the priorities, and the first geometric distances and the priorities may have a negative correlation to each other.

The method may further include calculating geometric distances and a geometric average distance for each of the plurality of clusters, and the excluding of at least one filter from among the plurality of filters may include excluding at least one filter from among the plurality of filters based on the geometric average distance and the geometric median.

The calculating of the geometric distances and the geometric average distance for each of the plurality of clusters may include calculating first geometric distances defined as distances between the first geometric median of the first cluster and the plurality of filters included in the first cluster based on the plurality of first filters included in the first cluster from among the plurality of clusters, calculating second geometric distances defined as distances between the second geometric median of the first cluster and the plurality of filters included in the second cluster based on the plurality of second filters included in the second cluster from among the plurality of clusters, calculating a first geometric average distance that is an average value of the first geometric distances, and calculating a second geometric average distance that is an average value of the second geometric distances.

The excluding of the at least one filter may include determining a first reduction ratio and a second reduction ratio based on the first geometric average distance and the second geometric average distance, respectively, excluding at least one filter from among the plurality of first filters based on the first reduction ratio and a first geometric median of the first cluster, and excluding at least one filter from among the plurality of second filters based on the second reduction ratio and a second geometric median of the second cluster, and a geometric average distance according to the first geometric average distance and the second geometric average distance and the reduction ratio according to the first reduction ratio and the second reduction ratio may have a negative correlation to each other, and when the first reduction ratio is greater than the second reduction ratio, a) the number of at least one filter excluded from the first cluster compared to the number of the plurality of first filters may be greater than or equal to b) the number of at least one filter excluded from the second cluster compared to the number of the plurality of second filters.

The method may further include calculating a norm of the plurality of filters included in each of the plurality of clusters and calculating a norm average corresponding to each of the plurality of clusters, wherein the excluding of the at least one filter from among the plurality of filters may include excluding at least one filter from among the plurality of filters based on the norm average and the geometric median.

The calculating of the norm of the plurality of filters and the norm average corresponding to each of the plurality of clusters may include calculating a norm of each of the plurality of first filters and calculating a norm of each of the plurality of first filters as a first norm average based on the plurality of first filters included in the first cluster from among the plurality of clusters, and calculating a norm of each of the plurality of second filters and calculating a norm of each of the plurality of second filters as a second norm average based on the plurality of second filters included in the second cluster from among the plurality of clusters.

The excluding of the at least one filter may include determining a first reduction ratio and a second reduction ratio based on the first norm average and the second norm average, respectively, excluding at least one filter from among the plurality of first filters based on the first reduction ratio and a first geometric median of the first cluster, and excluding at least one filter from among the plurality of second filters based on the second reduction ratio and a second geometric median of the second cluster, and a norm average according to the first norm average and the norm average and the reduction ratio according to the first reduction ratio and the second reduction ratio may have a negative correlation to each other, and when the first reduction ratio is greater than the second reduction ratio, a) the number of at least one filter excluded from the first cluster compared to the number of the plurality of first filters may be greater than or equal to b) the number of at least one filter excluded from the second cluster compared to the number of the plurality of second filters.

According to one or more embodiments, there is provided a computer device including memory comprising a convolutional layer having a plurality of filters, and a processor configured to generate a plurality of clusters by dividing the plurality of filters, to calculate a geometric median of each of the plurality of clusters and to exclude at least one filter from among the plurality of filters based on the geometric median for each of the plurality of clusters.

The processor may be further configured to convert the plurality of filters into a Laplacian matrix and to select k eigenvalues based on sizes of the eigenvalues in the Laplacian matrix, to obtain eigen vectors corresponding to each of the k eigenvalues and to determine the plurality of clusters by dividing the plurality of filters.

The processor may be further configured to calculate a first geometric median of the first cluster based on a plurality of first filters included in the first cluster from among the plurality of clusters.

The processor may be further configured to calculate first geometric distances defined as distances between the first geometric median and the plurality of first filters, to determine priorities based on the first geometric distances and to exclude at least one filter from among the plurality of first filters based on the priorities, and the first geometric distances and the priorities may have a negative correlation to each other.

The processor may be further configured to calculate a geometric distance and a geometric average distance for each of the plurality of clusters and to exclude at least one filter from among the plurality of filters based on the geometric average distance and the geometric median.

The processor may be further configured to calculate first geometric distances defined as distances between a first geometric median of the first cluster and a plurality of filters included in the first cluster based on a plurality of first filters included in the first cluster from among the plurality of clusters, to calculate second geometric distances defined as distances between a second geometric median of the second cluster and a plurality of filters included in the second cluster based on a plurality of second filters included in the second cluster from among the plurality of clusters, to calculate a first geometric average distance that is an average of the first geometric distances and to calculate a second geometric average distance that is an average of the second geometric distances.

The processor may be further configured to determine a first reduction ratio and a second reduction ratio based on the first geometric average distance and the second geometric average distance, respectively, to exclude at least one filter from among the plurality of first filters based on the first reduction ration and the first geometric median of the first cluster, and to exclude at least one from among the plurality of second filters based on the second reduction ratio and the second geometric median of the second cluster, and a geometric average distance according to the first geometric average distance and the second geometric average distance and the reduction ratio according to the first reduction ratio and the second reduction ratio may have a negative correlation to each other, and when the first reduction ratio is greater than the second reduction ratio, a) the number of at least one filter excluded from the first cluster compared to the number of the plurality of first filters may be greater than or equal to b) the number of at least one filter excluded from the second cluster compared to the number of the plurality of second filters.

The processor may be further configured to calculate a norm of the plurality of filters included in each of the plurality of clusters, to calculate a norm average corresponding to each of the plurality of clusters, and to exclude at least one filter from among the plurality of filters based on the norm average and the geometric median.

The processor may be further configured to calculate a norm of each of the plurality of first filters and to calculate a norm of each of the plurality of first filters as a first norm average based on the plurality of first filters included in the first cluster from among the plurality of clusters and to calculate a norm of each of the plurality of second filters and to calculate a norm of each of the plurality of second filters as a second norm average based on the plurality of second filters included in the second cluster from among the plurality of clusters.

The processor may be further configured to determine a first reduction ratio and a second reduction ratio based on the first geometric average distance and the second geometric average distance, respectively, to exclude at least one filter from among the plurality of first filters based on the first reduction ration and the first geometric median of the first cluster, and to exclude at least one from among the plurality of second filters based on the second reduction ratio and the second geometric median of the second cluster, and a norm average according to the first norm average and the norm average and the reduction ratio according to the first reduction ratio and the second reduction ratio may have a negative correlation to each other, and when the first reduction ratio is greater than the second reduction ratio, a) the number of at least one filter excluded from the first cluster compared to the number of the plurality of first filters may be greater than or equal to b) the number of at least one filter excluded from the second cluster compared to the number of the plurality of second filters.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a diagram for describing pruning;

FIG. 2 is a flowchart illustrating an operation of performing pruning based on clustering and priorities of a computer device according to an embodiment;

FIG. 3A is a flowchart illustrating an operation of performing pruning based on weights for clusters of a computer device according to an embodiment;

FIG. 3B is a flowchart illustrating an operation of performing pruning based on weights for clusters of a computer device according to another embodiment;

FIG. 4 is a diagram for describing a plurality of filters included in convolutional layers, according to an embodiment;

FIG. 5 is a diagram for describing an operation of dividing a plurality of filters of a computer device according to an embodiment;

FIG. 6 is a diagram for describing an operation of excluding at least one filter according to priorities of a computer device according to an embodiment;

FIG. 7 is a diagram for describing an operation of excluding at least one filter according to reduction ratios of a computer device according to an embodiment; and

FIG. 8 is a block diagram illustrating a configuration of a computer device according to an embodiment.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

Since various modifications and various embodiments are possible, specific embodiments are illustrated in the drawings and described in detail in the detailed description. Effects and features of the disclosure, and a method of achieving them will be apparent with reference to embodiments described below in detail in conjunction with the drawings. However, the disclosure is not limited to the embodiments disclosed herein, but may be implemented in a variety of forms.

Each logical block may indicate a part of a module, segment or code including one or more executable instructions for performing a specific logical function. In one embodiment, it should be noted that it is possible to execute the functions mentioned for each block differently from the order described. For example, even if two blocks are shown in succession, the functions described for each block may be performed simultaneously at the same time, or may be performed in reverse as the execution conditions or the environment changes. In the following embodiments, the singular expression includes a plurality of expressions unless the context is clearly different.

In the following embodiments, the terms such as comprising or having are meant to be the features described in the specification, or the element s are present, and the possibility of one or more other features or elements will be added, is not excluded in advance.

Instructions, which are executed through the processor of computer or other data processing equipment, may generate a unit for performing each function described by reference to the flowchart or block diagram. Instructions are mounted on computers, etc., allowing them to create processes that run on computers, etc. to perform a series of operating steps.

In this case, the term ‘˜unit’ used in the present embodiment refers to a component that performs specific functions performed by software or hardware such as a field programmable gate array (FPGA) or an application special integrated circuit (ASIC). However, ‘˜unit’ is not limited to being performed by software or hardware. ‘˜unit’ may be present in the form of data stored in a storage medium capable of addressing, or may be configured to allow one or more processors to perform specific functions.

In the drawings, for convenience of explanation, the sizes of elements may be exaggerated or reduced. For example, since the size and thickness of each component shown in the drawings are arbitrarily indicated for convenience of explanation, the disclosure is not necessarily limited to the illustration. In addition, in the present disclosure, expressions of greater or less than so as to determine whether specific conditions were satisfied or fulfilled are used, but this is just the description for expressing an example and does not exclude the description of above or less. The conditions described as ‘greater than or equal to’ may be replaced with ‘greater than’, the conditions described as ‘less than or equal to’ may be replaced with ‘less than’, and the conditions described as ‘greater than or equal to and less than’ may be replaced with ‘greater than and less than or equal to’.

Software may include a computer program, code, instruction, or one or more combinations thereof, and may configure a processing device to operate as desired or may independently or collectively command the processing device. Software and/or data may be permanently or temporarily embodied in any type of machine, component, physical device, virtual equipment, a computer storage medium or device, or signal waves transmitted so as to be interpreted by the processing device or to provide instruction or data to the processing device. Software may be dispersed on a computer system connected by a network, and may be stored or executed in a distributed method. The software and data may be stored on one or more computer readable recording medium.

As a representative example of an artificial neural network model that simulates the brain nerve, the neural network model according to the disclosure may indicate a convolutional neural network (CNN) having a convolutional layer.

The reduction ratio according to the disclosure may indicate the number of filters excluded from a cluster compared to the number of filters included in the cluster or the number of filters excluded from a layer compared to the number of filters included in the layer.

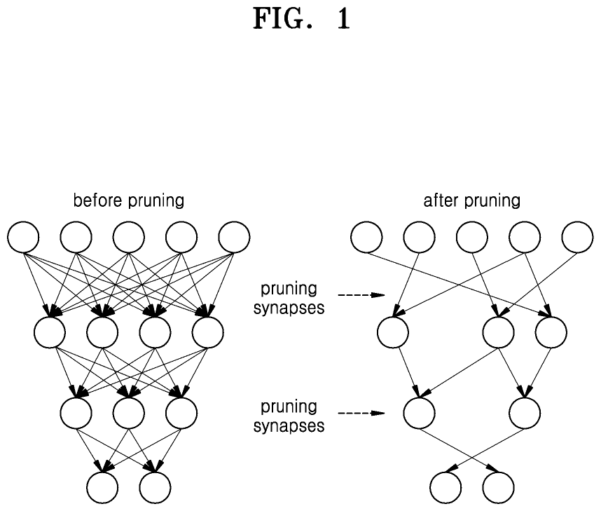

FIG. 1 is a diagram for describing pruning.

Pruning is one of the possibilities to improve the processing speed and refers to a technique for pruning or reducing filters included in a convolutional layer. For example, the processing speed may be improved by removing a filter, removing an attention head or removing some of layers based on the size of a weight.

Such pruning may be divided into structured pruning and unstructured pruning according to a method.

In structured pruning, a specific structure may be excluded from a neural network not to perform a matrix operation, and in unstructured pruning, a weight of a specific node may be set to 0 to indicate an operation to be performed. The pruning according to the disclosure may be a structured pruning for excluding a specific filter from the layer.

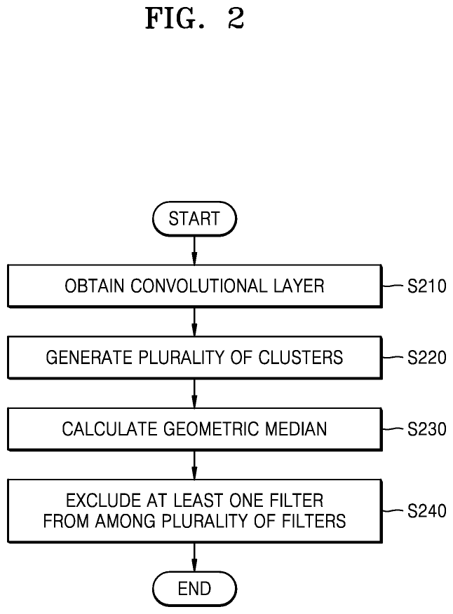

FIG. 2 is a flowchart illustrating an operation of performing pruning based on clustering of a computer device according to an embodiment. Although it is described for a single layer below, it is obvious by those skilled in the art that it is for convenience of explanation and a computer device may exclude a plurality of filters in each of the plurality of layers.

Referring to FIG. 2, the computer device may obtain a convolutional layer having a plurality of filters in operation S210. The computer device may obtain a convolutional layer in a learned neural network model or a neural network model in a learning process. The plurality of filters may perform a convolutional operation for each input and may generate and output a feature map according to operations. The feature map may be input to another convolutional layer and may be output as another feature map through a convolutional operation.

The computer device according to an embodiment may generate a plurality of clusters by dividing the plurality of filters in operation S220. Specifically, the computer device may perform a matrix conversion into an affinity matrix based on a plurality of filters.

The computer device may calculate a Laplacian matrix M, which is a conversion form of an affinity matrix A.

In this case, the Laplacian matrix M may be converted based on the following Equation 1.

$$M = {D}^{- \frac{1}{2}} {AD}^{\frac{1}{2}} \qquad [ Equation 1 ]$$

In Equation 1, M is a Laplacian matrix, A is an affinity matrix, and D is a diagonal matrix in which an element of (i,i) is the sum of an i-th row of A.

When you have an eigenvalue a that is a scalar value that satisfies Equation 2 in the relationship with a vector x, not all zero for the Laplacian matrix M, the vector x, which is not all zero, means an eigenvector.

$$Mx = ax \qquad [ Equation 2 ]$$

That is, the computer device may select k eigenvalues based on the order of sizes among eigenvalues that satisfy Equation 2 and may obtain k eigenvectors x corresponding to the k eigenvalues. At this time, k may be a pre-set value. For example, the computer device may select k eigenvalues in the order in which sizes of the eigenvalues increase, and may obtain k eigenvectors corresponding to the selected eigenvalues.

The computer device according to an embodiment may divide a plurality of filters, which are included in a layer, into a plurality of clusters based on at least one eigenvector having a maximum eigenvalue. The computer device may divide a plurality of filters, which are included in a layer, into a plurality of clusters based on at least one eigenvector having eigenvalues selected according to the order of sizes of the eigenvalues.

For example, the computer device may divide a plurality of first filters that are part of the plurality of filters, based on a first eigenvector and may divide a plurality of second filters that are part of the plurality of filters, based on a second eigenvector.

The computer device may perform the above-described operations to form one cluster by collecting filters with high affinity.

The computer device according to an embodiment may calculate a geometric median for each of the plurality of clusters in operation S230. For example, the computer device according to an embodiment may calculate a geometric median of the plurality of first filters included in a first cluster based on the first cluster from among the plurality of clusters. The geometric median of the first filters may be a first geometric median of the first cluster. Also, the computer device may calculate a second geometric median of a second cluster.

The computer device according to an embodiment may exclude at least one filter from among the plurality of filters based on the geometric median for each of the plurality of clusters in operation S240. For example, the computer device may exclude at least one filter from among the plurality of first filters included in the first cluster among the plurality of clusters.

The computer device according to an embodiment may calculate a plurality of first geometric distances by calculating a first geometric distance that is a distance between the first geometric median and the plurality of first filters and may determine priorities based on the first geometric distance. At this time, the first geometric distance and the priorities may have a negative correlation to each other. That is, the shorter the geometric distance, the higher the priority.

The computer device according to an embodiment may exclude at least one filter from the plurality of first filters based on the priorities. For example, a filter with high priority may be excluded. In other words, the computer device may exclude a filter based on a filter with a short geometric distance in the relationship with the first geometric median from among the plurality of first filters.

The computer device may exclude at least one filter from among the plurality of second filters by using the second geometric median even for the second cluster.

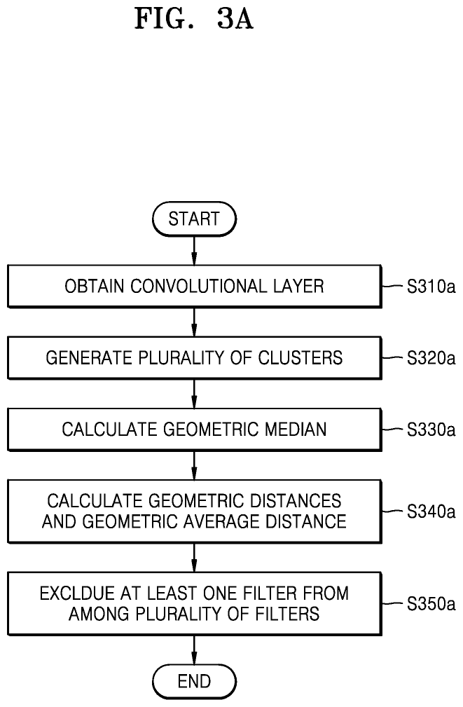

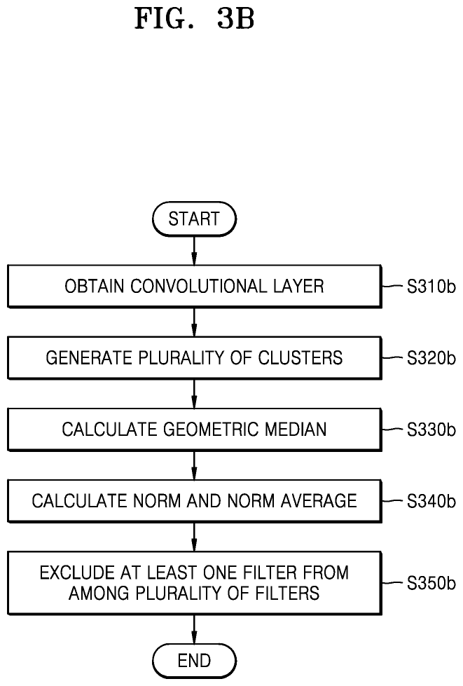

FIG. 3A is a flowchart illustrating an operation of performing pruning based on clustering and priorities of a computer device according to an embodiment. The computer device may exclude a filter by varying weights for each cluster in operation of FIG. 3A. As described above in an embodiment of the disclosure, operations S310a through S330a in FIG. 3A correspond to operations S210 to S230 in FIG. 2 and thus redundant descriptions therewith will be omitted. For example, the computer device may calculate a first geometric median of the first cluster based on the plurality of first filters included in the first cluster from among the plurality of clusters and may calculate a second geometric median of the second cluster based on the plurality of second filters included in the second cluster in operation S330a.

The computer device according to an embodiment may calculate geometric distances and a geometric average distance for each of the plurality of clusters in operation S340a.

For example, the computer device may calculate first geometric distances defined as distances between the first geometric median of the first cluster and the plurality of filters included in the first cluster. For example, the computer device may calculate second geometric distances defined as distances between the second geometric median of the second cluster and the plurality of filters included in the second cluster.

Also, the computer device may calculate a first geometric average distance that is an average value between the first geometric distances and may calculate a second geometric average distance that is an average value between the second geometric distances. The computer device may calculate a geometric distance and a geometric average distance for each of the plurality of clusters.

The computer device according to an embodiment may exclude at least one filter from among the plurality of filters based on the geometric average distance and the geometric median in operation S350a. Specifically, the computer device may exclude a filter by using a method of determining a reduction ratio by varying weights for each cluster.

The computer device according to an embodiment may determine a first reduction ratio and a second reduction ratio based on the first geometric average distance and the second geometric average distance, respectively. At this time, the geometric average distance according to the first geometric average distance and the second geometric average distance and the reduction ratio according to the first reduction ratio and the second reduction rate may have a negative correlation to each other. For example, the shorter the average distance, the higher the reduction ratio.

The computer device according to an embodiment may exclude at least one filter from among the plurality of first filters based on the first reduction ratio and the first geometric median of the first cluster. The computer device according to an embodiment may exclude at least one filter from among the plurality of second filters based on the second reduction ratio and the second geometric median of the second cluster.

When the first reduction ratio is greater than the second reduction ratio, the first reduction ratio, which is the number of at least one filter excluded from the first cluster compared to the number of the plurality of first filters, may be greater than or equal to the second reduction ratio, which is the number of at least one filter excluded from the second cluster compared to the number of the plurality of second filters.

This may be represented by Equation 2.

$$if {w}_{1} > {w}_{2} then \frac{{n}_{1}}{{N}_{1}} \geq \frac{{n}_{2}}{{N}_{2}} \qquad [ Equation 3 ]$$

w₁ represents a first reduction ratio, w₂ represents a second reduction ratio, n₁ represents the number of filters excluded from the first cluster, N₁ represents the number of filters included in the first cluster, n₂ represents the number of filters excluded from the second cluster, and N₂ represents the number of filters included in the second cluster. In other words, the computer device may determine in such a way that a cluster having the smaller the geometric median has a greater reduction ratio.

FIG. 3B is a flowchart illustrating an operation of performing pruning based on clustering of a computer device according to another embodiment. The computer device may exclude a filter by varying weights for each cluster in operation of FIG. 3B. As described above in an embodiment of the disclosure, operations S310b through S330b in FIG. 3B correspond to operations S210 to S230 in FIG. 2 and thus redundant descriptions therewith will be omitted. For example, the computer device may calculate a first geometric median of the first cluster based on the plurality of first filters included in the first cluster from among the plurality of clusters and may calculate a second geometric median of the second cluster based on the plurality of second filters included in the second cluster in operation S330b.

The computer device according to an embodiment may calculate a norm of filters included in each of the plurality of clusters in operation S340b and may calculate an average norm for each of the plurality of clusters. At this time, norm may be sizes of vectors and a concept including L1norm or L2norm. That is, the computer device may calculate a norm of filters through a L1 norm operation, or may calculate an average norm for each of the plurality of clusters, or may calculate a norm of filters through a L2 norm operation and may calculate average norm for each of the plurality of clusters.

For example, the computer device may calculate a norm of each of the plurality of filters included in the first cluster and may calculate an average of a norm of the plurality of filters to determine a first norm average corresponding to the first cluster. Also, the computer device may calculate a norm of each of the plurality of filters included in the second cluster and may calculate an average of a norm of the plurality of filters to determine a second norm average corresponding to the second cluster.

The computer device according to an embodiment may exclude at least one filter from among the plurality of filters based on the average norm in operation S350b. Specifically, the computer device may exclude a filter by using a method of determining a reduction ratio by varying weights for each cluster according to the average norm.

The computer device according to an embodiment may exclude at least one filter from among the plurality of first filters based on the first reduction ratio and the first norm average of the first cluster. The computer device according to an embodiment may exclude at least one filter from among the plurality of first filters based on the second reduction ratio and the second norm average of the second cluster.

When the first reduction ratio is greater than the second reduction ratio, the first reduction ratio, which is the number of at least one filter excluded from the first cluster compared to the number of the plurality of first filters, may be greater than or equal to the second reduction ratio, which is the number of at least one filter excluded from the second cluster compared to the number of the plurality of second filters. In other words, the computer device may determine in such a way that a cluster having the smaller L2-norm average has a greater reduction ratio.

In the computer device according to other embodiments, when the operation shown in FIGS. 2, 3A and 3B is performed on a plurality of layers, a reduction ratio may be different in each layer, depending on the number of filters in the layer. For example, the computer device may determine in such a way that the higher reduction ratio as the number of filters included in the layer increases.

In addition, the computer device may perform merging of the operation when performing the operation in FIGS. 2, 3A and 3B. For example, the computing device may determine priorities of the filters in FIG. 2 and may determine a reduction ratio of a cluster in FIG. 3A or 3B.

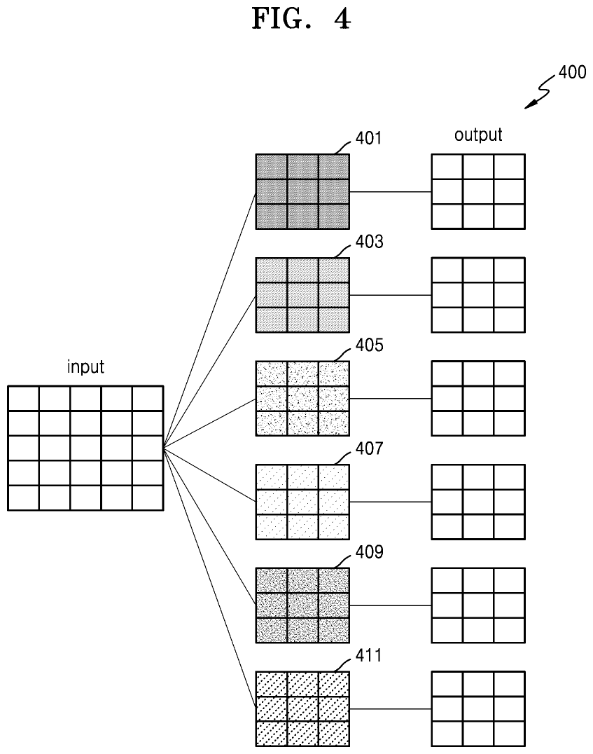

FIG. 4 is a diagram for describing a plurality of filters included in convolutional layers, according to an embodiment. In FIG. 4, for convenience of explanation, it is described based on the operation of a single channel and a single layer, but it may also be applied to an operation for multi-channels and multiple layers.

Referring to FIG. 4, an operation in a convolutional layer 400 for obtaining a 3×3 output by allowing a 5×5 input data to pass through a plurality of 3×3 filters will be illustrated. The convolutional layer 400 may include a plurality of filters 401, 403, 405, 407, 409, and 411. The plurality of filters 401, 403, 405, 407, 409, and 411 may perform a matrix conversion according to affinity and may be divided into clusters.

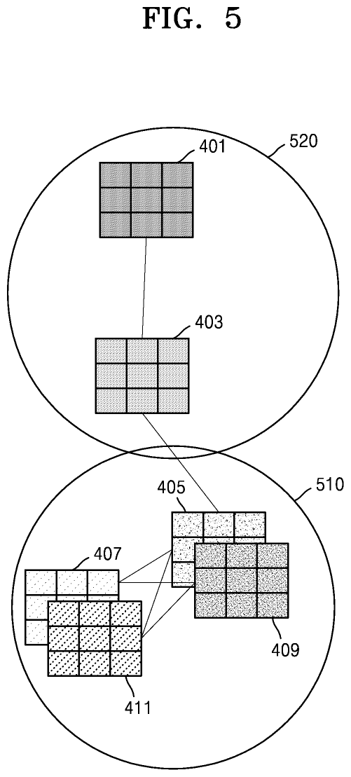

FIG. 5 is a diagram for describing an operation of dividing the plurality of filters 401, 403, 405, 407, 409, and 411 of the computer device according to an embodiment. The computer device may perform a matrix conversion by using an affinity matrix or a Laplacian matrix based on the plurality of filters. The computer device may divide a plurality of filters, which are included in a layer, into a plurality of clusters based on at least one eigenvector selected according to the order of sizes of the eigenvalues.

Referring to FIG. 5, the third through sixth filters 405, 407, 409, and 411 may be divided into the first cluster 510, and the first filter 401 and the second filter 403 may be divided into the second cluster 520.

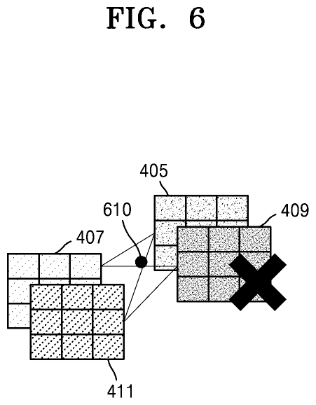

FIG. 6 is a diagram for describing an operation of excluding at least one filter according to priorities of a computer device according to an embodiment. This is not a graph through a matrix conversion, but a conceptual schematic diagram of the distance between the filters for explanation. As described above, the computer device may exclude at least one filter from the cluster according to priorities.

Referring to FIG. 6, the first cluster 510 may include the third through sixth filters 405, 407, 409, and 411. The computer device may calculate a geometric median 610 between the third through sixth filters 405, 407, 409, and 411. The computer device may calculate a geometric distance between the geometric median and the third through sixth filters 405, 407, 409, and 411. The computer device may exclude a filter based on a filter with a short geometric distance. For example, when performing pruning, the computer device may exclude the fifth filter 409 as a priority when a geometric distance between the fifth filter 409 and the geometric median 610 is short.

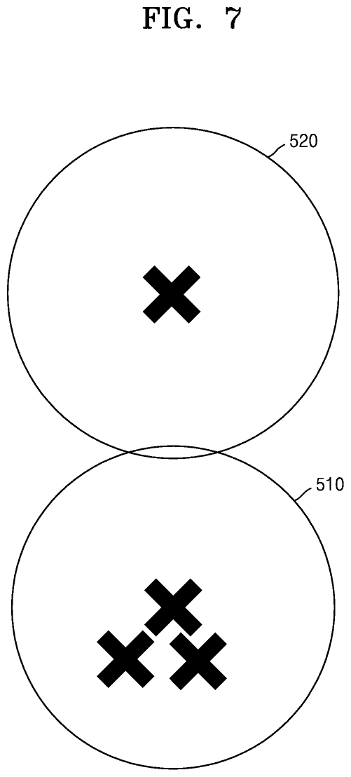

FIG. 7 is a diagram for describing an operation of excluding at least one filter according to reduction ratios of a computer device according to an embodiment. As described above, the computer device may exclude at least one filter by varying a reduction ratio for each cluster according to the reduction ratio.

Referring to FIG. 7, the first cluster 510 may include the third through sixth filters 405, 407, 409, and 411, and the second cluster 510 may include the first filter 401 and the second filter 403.

The computer device may calculate a geometric distance and a geometric average distance for each of the plurality of clusters. The computer device may calculate first geometric distances defined as distances between the first geometric median of the first cluster 510 and the plurality of filters included in the first cluster 510, thereby calculating a first geometric average distance that is an average value of the first geometric distances.

The computer device may calculate second geometric distances defined as distances between the second geometric median of the second cluster 520 and the plurality of filters included in the second cluster 520, thereby calculating a second geometric average distance that is an average value of the second geometric distances.

In the computer device, when the first geometric average distance of the first cluster 510 is shorter than the second geometric average distance of the second cluster 520, the number of at least one filter excluded from the first cluster compared to the number of the plurality of first filters may be greater than or equal to the number of at least one filter excluded from the second cluster compared to the number of the plurality of second filters.

As shown in FIG. 7, when the first geometric average distance of the first cluster 510 is longer than the second geometric average distance of the second cluster 520, the number (3) of at least one filter excluded from the first cluster 510 compared to the number (4) of the plurality of first filters may be greater than the number (1) of at least one filter excluded from the second cluster 520 compared to the number (2) of the plurality of second filters.

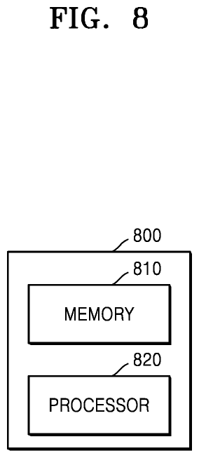

FIG. 8 is a block diagram illustrating a configuration of a computer device according to an embodiment.

Although it is shown that a computer device 800 includes memory 810 and a processor 820, the disclosure is not limited thereto. Each of the memory 810 and the processor 820 may be present as one physically independent component.

The memory 810 may store various data for an overall operation of the computer device 800 such as a program for processing or controlling the processor 820 in the computer device.

The memory 810 may store a plurality of applications (application programs) driven in the computer device 800, and data and commands for an operation of the computer device 800. The memory 810 may be implemented with internal memory such as read only memory (ROM), random access memory (RAM) included in the processor 820 or may be implemented as separate memory with the processor 820.

The memory 810 according to an embodiment may store a neural network model and a convolutional layer.

The processor 820 may be a configuration for overall control of the computer device 800. For example, the processor 820 may control the computer device 800 to perform the operation in FIGS. 2 and 3.

Specifically, the processor 820 may control the operation of the computer device 800 by using various programs stored in the memory 810 of the computer device 800. The processor 820 may include a central processing unit (CPU), RAM, ROM, a system bus, and the like. The processor 820 may be implemented with a single CPU or a plurality of CPUs (or digital signal processors (DSPs), system on chips (SoCs)). In an embodiment, the processor 820 may be implemented with a DSP for processing digital signals, a microprocessor, or a time controller (TCON). However, the disclosure is not limited thereto, and the processor 820 may include one or more among a CPU, a microcontroller unit (MCU), a micro processing unit (MPU), a controller, an application processor (AP), a communication processor (CP), and an ARM processor, or may be defined as a corresponding term. Also, the processor 820 may also be implemented with a SoC or a large scale integration (LSI) in which a processing algorithm is embedded, or may also be implemented in the form of a field programmable gate array (FPGA).

The processor 820 according to an embodiment may generate a plurality of clusters by dividing a plurality of filters, may calculate a geometric median of each of the plurality of clusters, and may exclude at least one filter from among the plurality of filters based on the geometric median of each of the plurality of clusters.

The processor 820 according to an embodiment may convert the plurality of filters into a Laplacian matrix, may obtain at least one eigenvector having a maximum eigenvalue in the Laplacian matrix, and may divide the plurality of filters by using at least one eigenvector to determine a plurality of clusters.

The processor 820 according to an embodiment may select k eigenvalues based on the size of eigenvalues in the Laplacian matrix, may obtain eigenvectors corresponding to each of the k eigenvalues, and may divide the plurality of filters by using the eigenvectors to determine the plurality of clusters.

The processor 820 according to an embodiment may calculate a first geometric median of a first cluster based on the plurality of first filters included in the first cluster from among the plurality of clusters.

The processor 820 according to an embodiment may calculate first geometric distances defined as distances between the first geometric median and the plurality of first filters, may determine priorities based on the first geometric distances and may exclude at least one filter from among the plurality of first filters based on the priorities. The first geometric distance and the priorities may have a negative correlation to each other.

The processor 820 according to an embodiment may calculate a geometric distance and a geometric average distance for each of the plurality of clusters and may exclude at least one filter from among the plurality of filters based on the geometric average distance and the geometric median.

The processor 820 according to an embodiment may calculate first geometric distances defined as distances between the first geometric median of the first cluster and the plurality of filters included in the first cluster based on the plurality of first filters included in the first cluster from among the plurality of clusters, may calculate second geometric distances defined as distances between a second geometric median of the second cluster and the plurality of filters included in the second cluster based on the plurality of second filters included in the second cluster from among the plurality of clusters, and may calculate a first geometric average distance that is an average value of the first geometric distances and may calculate a second geometric average distance that is an average value of the second geometric distances.

The first reduction ratio and the second reduction ratio may be determined based on the first geometric average distance and the second geometric average distance, respectively, and at least one first filter from among the plurality of first filters may be excluded based on the first reduction ration and the first geometric median of the first cluster, and at least one second filter from among the plurality of second filters may be excluded based on the second reduction ratio and the second geometric median of the second cluster.

The processor 820 according to an embodiment may calculate a norm of the plurality of filters included in each of the plurality of clusters, may calculate a norm average corresponding to each of the plurality of clusters, and may exclude at least one filter from among the plurality of filters based on the norm average and the geometric median.

The processor 820 according to an embodiment may calculate a norm for each of the plurality of first filters based on the plurality of first filters included in the first cluster from among the plurality of clusters, may calculate a norm of each of the plurality of second filters based on the plurality of second filters included in the second cluster from among the plurality of clusters, and may calculate a norm for each of the plurality of second filters and may calculate a second norm average that is an average of a norm of each of the plurality of second filters.

The processor 820 according to an embodiment may determine a first reduction ratio and a second reduction ratio based on the first norm average and the second norm average, respectively, may exclude at least one filter from among the plurality of first filters based on the first reduction ration and the first geometric median of the first cluster, and may exclude at least one filter from among the plurality of second filters based on the second reduction ratio and the second geometric median of the second cluster.

At this time, when the first reduction ratio is greater than the second reduction ratio, a) the number of at least one filter excluded from the first cluster compared to the number of the plurality of first filters may be greater than or equal to the number of at least one filter excluded from the second cluster compared to the number of the plurality of second filters.

The computer device may perform clustering and may perform pruning by applying a reduction ratio for each cluster according to the above-described embodiments. Specifically, the computer device may perform clustering, may determine priorities of filters to be excluded from the cluster based on the priorities and may determine a reduction ratio between clusters based on the reduction ratio, thereby performing pruning. The computer device according to another embodiment may also determine reduction ratios between layers based on the number of filters to be included in the layer.

In addition, the computer device may fine adjust parameters by using a neural network excluded through the filter through pruning.

According to an embodiment of the disclosure, filter pruning or filter reduction may be performed by using a geometric median based on clustering. According to an embodiment, filters belonging to the layer of the neural network may be effectively removed to maintain an inference performance or to minimize performance degradation, thereby improving processing speed. According to an embodiment of the disclosure, the possibility that similar filters may be redundantly present compared to the performing pruning based on a single geometric median in the layer, may be reduced.

Although the embodiments were described by the limited embodiments and drawings, if they have a common knowledge in the relevant technical field, various modifications and modifications can be made from the above description. For example, the techniques described in a different order from the described method, or/or combined or combined in a different form from the method described in the system, structure, device, circuit, etc. Alternatively, even if it is replaced or substituted by an equal object, appropriate results can be achieved.

Thus, other embodiments, one embodiment, and the scope of claims are also in the scope of the claims that are described later.

According to an embodiment, filter pruning or filter reduction may be performed.

The effects of the disclosure are not limited to the above-described effects.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope of the disclosure as defined by the following claims.

What is claimed is:

1. A method for pruning filters in a neural network, the method comprising:
obtaining a convolutional layer having a plurality of filters;
generating a plurality of clusters by dividing the plurality of filters;
calculating a geometric median of each of the plurality of clusters; and
excluding at least one filter from among the plurality of filters based on the geometric median for each of the plurality of clusters.

2. The method of claim 1, wherein the generating of the plurality of clusters comprises:
converting the plurality of filters into a Laplacian matrix;
selecting k eigenvalues from the Laplacian matrix based on sizes of eigenvalues;
obtaining eigenvectors respectively corresponding to the k eigenvalues; and
determining the plurality of clusters by dividing the plurality of filters using the eigenvectors.

3. The method of claim 1, wherein the calculating of the geometric median of each of the plurality of clusters comprises calculating a first geometric median of the first cluster based on a plurality of first clusters included in a first cluster from among the plurality of clusters.

4. The method of claim 3, further comprising:
calculating first geometric distances defined as distances between the first geometric median and the plurality of first filters; and
determining priorities based on the first geometric distances,
wherein the excluding of the at least one filter comprises excluding at least one filter from among the plurality of first filters based on the priorities, and
the first geometric distances and the priorities have a negative correlation to each other.

5. The method of claim 1, further comprising calculating a geometric distance and a geometric average distance for each of the plurality of clusters, wherein the excluding of the at least one filter from among the plurality of filters comprises excluding at least one filter from among the plurality of filters based on the geometric average distance and the geometric median.

6. The method of claim 5, wherein the calculating of the geometric distance and the geometric average distance for each of the plurality of clusters comprises:
calculating first geometric distances defined as distances between the first geometric median of the first cluster and the plurality of filters included in the first cluster based on the plurality of first filters included in the first cluster from among the plurality of clusters;
calculating second geometric distances defined as distances between the second geometric median of the second cluster and the plurality of filters included in the second cluster based on the plurality of second filters included in the second cluster among the plurality of clusters;
calculating a first geometric average distance defined as an average value between the first geometric distances; and
calculating a second geometric average distance defined as an average value between the second geometric distances.

7. The method of claim 6, wherein the excluding of the at least one filter comprises:
determining a first reduction ratio and a second reduction ratio based on the first geometric average distance and the second geometric average distance, respectively;
excluding at least one filter from among the plurality of first filters based on the first reduction ratio and a first geometric median of the first cluster; and
excluding at least one filter from among the plurality of second filters based on the second reduction ratio and a second geometric median of the second cluster, wherein a geometric average distance according to the first geometric average distance and the second geometric average distance and the reduction ratio according to the first reduction ratio and the second reduction ratio have a negative correlation to each other, and
when the first reduction ratio is greater than the second reduction ratio, a) the number of at least one filter excluded from the first cluster compared to the number of the plurality of first filters is greater than or equal to b) the number of at least one filter excluded from the second cluster compared to the number of the plurality of second filters.

8. The method of claim 1, further comprising calculating a norm of the plurality of filters included in each of the plurality of clusters and calculating a norm average corresponding to each of the plurality of clusters, wherein the excluding of the at least one filter from among the plurality of filters comprises excluding at least one filter from among the plurality of filters based on the norm average and the geometric median.

9. The method of claim 8, wherein the calculating of the norm of the plurality of filters and the norm average corresponding to each of the plurality of clusters comprises:
calculating a norm of each of the plurality of first filters and calculating a norm of each of the plurality of first filters as a first norm average based on the plurality of first filters included in the first cluster from among the plurality of clusters; and
calculating a norm of each of the plurality of second filters and calculating a norm of each of the plurality of second filters as a second norm average based on the plurality of second filters included in the second cluster from among the plurality of clusters.

10. The method of claim 9, wherein the excluding of the at least one filter comprises:
determining a first reduction ratio and a second reduction ratio based on the first norm average and the second norm average, respectively;
excluding at least one filter from among the plurality of first filters based on the first reduction ratio and a first geometric median of the first cluster; and
excluding at least one filter from among the plurality of second filters based on the second reduction ratio and a second geometric median of the second cluster, and
a norm average according to the first norm average and the norm average and the reduction ratio according to the first reduction ratio and the second reduction ratio have a negative correlation to each other, and
when the first reduction ratio is greater than the second reduction ratio, a) the number of at least one filter excluded from the first cluster compared to the number of the plurality of first filters is greater than or equal to b) the number of at least one filter excluded from the second cluster compared to the number of the plurality of second filters.

11. A computer device for pruning filters in a neural network, the computer device comprising:
memory comprising a convolutional layer having a plurality of filters; and
a processor configured to generate a plurality of clusters by dividing the plurality of filters, to calculate a geometric median for each of the plurality of clusters, and to exclude at least one filter from among the plurality of filters based on the geometric median for each of the plurality of clusters.

12. The computer device of claim 11, wherein the processor is further configured to convert the plurality of filters into a Laplacian matrix and to select k eigenvalues based on sizes of the eigenvalues in the Laplacian matrix, to obtain eigen vectors corresponding to each of the k eigenvalues, and to determine the plurality of clusters by dividing the plurality of filters.

13. The computer device of claim 10, wherein the processor is further configured to calculate a first geometric median of the first cluster based on a plurality of first clusters included in a first cluster from among the plurality of clusters.

14. The computer device of claim 13, wherein the processor is further configured to calculate first geometric distances defined as distances between the first geometric median and the plurality of first filters, to determine priorities based on the first geometric distances, and to exclude at least one filter from among the plurality of first filters based on the priorities, and the first geometric distances and the priorities have a negative correlation to each other.

15. The computer device of claim 10, wherein the processor is further configured to calculate a geometric distance and a geometric average distance for each of the plurality of clusters and to exclude at least one filter from among the plurality of filters based on the geometric average distance and the geometric median.

16. The computer device of claim 15, wherein the processor is further configured to calculate first geometric distances defined as distances between a first geometric median of the first cluster and a plurality of filters included in the first cluster based on a plurality of first filters included in the first cluster from among the plurality of clusters, to calculate second geometric distances defined as distances between a second geometric median of the second cluster and a plurality of filters included in the second cluster based on a plurality of second filters included in the second cluster from among the plurality of clusters, to calculate a first geometric average distance defined as an average of the first geometric distances, and to calculate a second geometric average distance defined as an average of the second geometric distances.

17. The computer device of claim 16, wherein the processor is further configured to determine a first reduction ratio and a second reduction ratio based on the first geometric average distance and the second geometric average distance, respectively, to exclude at least one filter from among the plurality of first filters based on the first reduction ration and the first geometric median of the first cluster, and to exclude at least one from among the plurality of second filters based on the second reduction ratio and the second geometric median of the second cluster, and a geometric average distance according to the first geometric average distance and the second geometric average distance and the reduction ratio according to the first reduction ratio and the second reduction ratio have a negative correlation to each other, and when the first reduction ratio is greater than the second reduction ratio, a) the number of at least one filter excluded from the first cluster compared to the number of the plurality of first filters is greater than or equal to b) the number of at least one filter excluded from the second cluster compared to the number of the plurality of second filters.

18. The computer device of claim 10, wherein the processor is further configured to calculate a norm of the plurality of filters included in each of the plurality of clusters, to calculate a norm average corresponding to each of the plurality of clusters, and to exclude at least one filter from among the plurality of filters based on the norm average and the geometric median.

19. The computer device of claim 18, wherein the processor is further configured to calculate a norm of each of the plurality of first filters and to calculate a norm of each of the plurality of first filters as a first norm average based on the plurality of first filters included in the first cluster from among the plurality of clusters and to calculate a norm of each of the plurality of second filters and to calculate a norm of each of the plurality of second filters as a second norm average based on the plurality of second filters included in the second cluster from among the plurality of clusters.

20. The computer device of claim 19, wherein the processor is further configured to determine a first reduction ratio and a second reduction ratio based on the first geometric average distance and the second geometric average distance, respectively, to exclude at least one filter from among the plurality of first filters based on the first reduction ration and the first geometric median of the first cluster, and to exclude at least one from among the plurality of second filters based on the second reduction ratio and the second geometric median of the second cluster, and a norm average according to the first norm average and the norm average and the reduction ratio according to the first reduction ratio and the second reduction ratio have a negative correlation to each other, and when the first reduction ratio is greater than the second reduction ratio, a) the number of at least one filter excluded from the first cluster compared to the number of the plurality of first filters is greater than or equal to b) the number of at least one filter excluded from the second cluster compared to the number of the plurality of second filters.
